(19) United States
(12) Patent Application Publication
(10) Pub. No.: US 2020/0064585 A1
(43) Pub. Date: Feb. 27, 2020

(54) FOCUS-ADJUSTABLE OPTICS

(71) Applicant: SICK AG, Waldkirch (DE)

(72) Inventors: Florian SCHNEIDER, Waldkirch (DE); Georg SCHÄFER, Waldkirch (DE); Tobias PONTIGGIA, Waldkirch (DE)

(21) Appl. No.: 16/545,609

(22) Filed: Aug. 20, 2019

(30) Foreign Application Priority Data
Aug. 27, 2018 (DE) 102018120807.3

(51) Int. Cl. G02B 7/04; H02K 11/215; H02K 41/035

(52) U.S. Cl. CPC G02B 7/04; H02K 41/0356; H02K 11/215

(57) ABSTRACT

Focus-adjustable optics (28) for an optoelectronic sensor (10), the focus-adjustable optics (28) having at least one optical element (14), an actuator (34) for moving the optical element (14), and a swivel arm (30), with the optical element (14) being arranged on the swivel arm (30) and the actuator (34) engaging the swivel arm (34) for moving the swivel arm (30) with the optical element (14) relative to a bearing point (32), wherein the swivel arm (30) is configured as a two-sided lever having a first lever arm on one side of the bearing point (32) and a second lever arm on another side of the bearing point (32), the optical element (14) being arranged on the first lever arm and the actuator (34) being arranged at the second lever arm, and wherein the swivel arm (30) is balanced.

The invention relates to focus-adjustable optics for an optoelectronic sensor and a method for adjusting the focus.

Focusing of an optical system is relevant for a very large group of optoelectronic sensors. This applies both to the transmitting side, when a light beam is to be transmitted or a light pattern is to be projected, and to the receiving side for the detection of light beams or images. An example for focusing on the transmitting side is a barcode scanner with a focused reading beam, and an example for focusing on the receiving side is a camera for the focused acquisition of images and in particular for reading barcodes or 2D codes, without excluding other optoelectronic sensors with focus adjustment. As illustrated by a further example of a 3D camera with a projected illumination pattern, there is also a need for focusing on both the transmitting and receiving sides.

These sensors are used, among other applications, in logistics and factory automation. A common detection situation is the mounting of the sensor above a conveyor belt. During the relative movement of the object stream on the conveyor belt, the sensor acquires information about the objects, for example by measuring the objects or reading codes attached to them.

In many situations, a fixed depth of field is not sufficient to generate a sharp light spot or to acquire a sharp image and reliably read codes. Then, a focus adjustment is used to adjust the transmitted light beam, or the receiving side focus plane, to the required working distance. This is often associated with an autofocus, which determines the distance to the object to be detected, and adjusts the focus position accordingly. There are different technologies for the focus adjustment. Typically, the position of the optics relative to the light transmitter or light receiver is varied.

This movement can be driven by a stepper motor. For example, the stepper motor generates an up and down movement of a transmission lens which is supported by a leaf spring via an eccentric element and a swivel lever, the up and down movement being defined by the respective step position. Each step position of the stepper motor is thus assigned to a specific distance between transmission lens and laser diode, which corresponds to a focusing of the laser beam to the corresponding focus value. However, this is expensive, and the stepper motor needs a lot of space. For a camera-based code reader, EP 2 498 113 A1 proposes a focus adjustment using a motor-driven cam disk and a parallel guide of the lens in a spring bearing with several flat leaf springs. This does not eliminate the disadvantages in terms of costs and size.

As an alternative to a stepper motor, voice coils are also used. Their operating principle is based on the Lorentz force exerted on a coil with a current flow in a magnetic field. DE 10 2016 112 123 A1 discloses a barcode scanner with transmission optics on a swivel arm that is swivelled by means of a voice coil actuator for focusing the reading beam. The swivel arm is mounted at one end and moved by the voice coil actuator at the other end. This results in a movement of the optics that can only be a reduction, i.e. where the actuator moves a larger distance than the optics. Voice coil actuators are usually supported freely or on thin bending beams, which leads to a high mechanical shock sensitivity.

EP 1 513 094 B1, EP 1 698 995 B1 and EP 1 698 996 B1 each describe a code reader wherein a mirror is arranged on a swivel arm whose movement shortens or lengthens the light path between the lens and the reception optics in order to adjust the effective focus position. However, the movement of the mirror also causes a change in position of the optical axis, so that this is not suitable for use in a code scanner on the transmitting side. The reflective optics are also not suitable for all sensor designs and configurations.

EP 2 112 540 B1 discloses a stationary camera-based code reader with a line camera whose captured image lines are successively combined in the course of a conveying movement to form an overall image. Reception optics are arranged on a swing arm which is swivelled parallel to the image line for focus adjustments. This means that the inevitable shift in the detection area associated with the swivel is irrelevant, since merely a certain mutual offset of the individual lines results. EP 2 112 540 B1 does not deal with the details of actuation and configuration of the focus adjustment nor the focusing of a transmission beam in a code scanner.

EP 2 657 881 A1 introduces an illumination device having an optics holder that moves transmission optics relative to a light transmitter and thus focuses the illumination range to a working distance. The optics holder is fixed at a fixed point, and thus the movement is fixedly guided. The fixed point again is located at one end of the optics holder in this case. EP 2 657 881 A1 does not explain any details about the generation of the movement.

It is therefore an object of the invention to achieve an improved focus adjustment in a code reader.

This object is satisfied by focus-adjustable optics for an optoelectronic sensor, the focus-adjustable optics having at least one optical element, an actuator for moving the optical element, and a swivel arm, with the optical element being arranged on the swivel arm and the actuator engaging the swivel arm for moving the swivel arm with the optical element relative to a bearing point, wherein the swivel arm is configured as a two-sided lever having a first lever arm on one side of the bearing point and a second lever arm on another side of the bearing point, the optical element being arranged on the first lever arm and the actuator being arranged at the second lever arm, and wherein the swivel arm is balanced.

The object is also satisfied by a method for adjusting a focus of focus-adjustable optics of an optoelectronic sensor, wherein at least one optical element is moved by an actuator by means of the optical element being arranged on a swivel arm where the actuator engages in order to move the swivel arm with the optical element relative to a bearing point, wherein the swivel arm is formed as a two-sided lever having a first lever arm on one side of the bearing point and a second lever arm on another side of the bearing point, the optical element being arranged on the first lever arm and the actuator being arranged at the second lever arm, and wherein the swivel arm is balanced.

The optics have at least one optical element, such as a lens, which is moved by an actuator. This movement is generated indirectly via a swivel arm whereon the optical element is arranged, and where the actuator engages in order to move the swivel arm with respect to a bearing point.

The invention starts from the basic idea of configuring the swivel arm as a two-sided lever similar to a seesaw. The bearing point is not at one end of the swivel arm, but at the center in case of lever arms of a same length, or with an offset to the center in case of different lever arms. The optical element is arranged on a first lever arm, while the actuator acts on the other, second lever arm. As the actuator moves its lever arm up and down, the working distance of the optical element on the opposite lever arm and thus the focus position varies. The lever ratio defined by the length of the lever arms determines the position accuracy, i.e. the transmission ratio translating movements of the actuator into movements of the optical element.

According to invention, the swivel arm is balanced, thus is in balance with respect to the bearing point. In technical terms, this means that the torque of the first lever arm and the optical element attached thereto is equal to the torque of the second lever arm and those elements of the actuator, if any, which add to the load of the second lever arm.

The invention has the advantage that the sensitivity to vibrations or mechanical shock is significantly reduced. The improved stability in turn ensures more reliable focusing.

The swivel arm preferably is balanced by selection and arrangement of the swivel arm, the optical element and the actuator. Throughout this specification, the terms preferred or preferably refer to an advantageous, but completely optional feature. In this embodiment, the design or configuration of the focus-adjustable optics is responsible for the balance. The swivel arm itself, its bearing point, the optical element and the actuator, as well as their arrangement on the swivel arm, are coordinated to achieve the desired equilibrium. This means that there are additional costs for balancing only once in advance for the design, and not repeatedly during manufacturing of the respective optics.

The swivel arm preferably is balanced by adding or removing material of the swivel arm, or the swivel arm is balanced by shifting at least one of the bearing point, the position of the optical element and the position of the actuator relative to the swivel arm. These are measures for an individual balancing of the optics, for example during the manufacturing process, which could also further refine an already balanced design. One conceivable measure is to vary the levers, i.e. to change the bearing point and/or the positions of the optical element or actuator with respect to the swivel arm. Another conceivable measure affects the masses by removing material from the swivel arm or by attaching additional weights to it, in order to balance the swivel arm somewhat similarly to balancing a tyre.

A free support preferably is provided between actuator and second lever arm. The free support for example comprises merely a thin bending beam, and in any case nothing to hold the swivel arm in place.

The actuator preferably is configured as a voice coil actuator. A voice coil actuator is freely supported as described in the previous paragraph and thus in itself cannot provide robustness against vibration or shock. Therefore, the balanced swivel arm according to the invention is particularly well suited for such actuators. Focus adjustments based on stepper motors, on the other hand, would already show a lower shock sensitivity in the first place, which nevertheless also can be improved by balancing.

The voice coil actuator preferably comprises a coil attached to the second lever arm and a stationary permanent magnet in whose magnetic field the coil is arranged. Stationary means that the permanent magnet is the fixed point for the swivel movement, i.e. it rests in the sensor which uses the focus-adjustable optics. A suitably controlled current flow through the coil generates a Lorentz force to move into the controlled focus position. The permanent magnet preferably generates a homogeneous magnetic field. This ensures a linear adjustment and a high efficiency of the applied force.

The focus-adjustable optics preferably comprise a position sensor for determining the respective position of the optical element. The position sensor may for example be a Hall sensor. This provides feedback as to whether the desired focus position is actually achieved by controlling the actuator. The position sensor can determine the position of the swivel arm at an arbitrary point, because this can then be converted to the position of the optical element using the known geometry. Preferably, however, the position sensor is located at a sufficient distance from the bearing point in order to experience sufficient movement. Preferably, the position sensor is located near the optical element in order to detect even more precise position information.

The focus-adjustable optics preferably comprise a controller for controlling the focus position of the optical element based on position information of the position sensor. It is thus possible to compensate for deviations between the desired and actual focus position. In addition, the optical element is quickly returned to the desired focus position in the event of external influences such as vibration or shock.

The swivel arm preferably is mounted and arranged with respect to the actuator such that the swivel movement is perpendicular to the longitudinal extension of the swivel arm. In particular, a coil attached to the swivel arm is arranged in the magnetic field in such a way that a vertical swivel movement is generated, which is particularly effective for the focus adjustment. The swivel arm preferably is mounted at the bearing point by means of a leaf spring. A leaf spring is inexpensive and stable, and it can easily absorb the swivel movement.

In a preferred embodiment, there is provided a sensor comprising focus-adjustable optics having at least one optical element, an actuator for moving the optical element, and a swivel arm, with the optical element being arranged on the swivel arm and the actuator engaging the swivel arm for moving the swivel arm with the optical element relative to a bearing point, wherein the swivel arm is configured as a two-sided lever having a first lever arm on one side of the bearing point and a second lever arm on another side of the bearing point, the optical element being arranged on the first lever arm and the actuator being arranged at the second lever arm, and wherein the swivel arm is balanced, the sensor further comprising at least one of a light receiver with the focus-adjustable optics being used as reception optics and a light transmitter with the focus-adjustable optics being used as transmission optics. The sensor thus uses focus-adjustable optics according to the invention as reception optics for a light receiver or as transmission optics for a light receiver. The focus-adjustable optics could also be used as both reception optics for a light receiver and as transmission optics for a light transmitter, or two focus-adjustable optics are used as separate reception optics and transmission optics, respectively.

The focus-adjustable optics are used to detect a sharp light spot or acquire a sharp image, or to generate a sharp light spot or a sharp illumination pattern in the scenery, respectively. The sensor preferably is a code reader. This in particular can be a camera-based code reader with focus-adjustable optics according to the invention for its image sensor in order to acquire sharp images, with subsequent image processing for locating and reading codes, or a code scanner whose reading beam generates a sharp light spot on the code by means of focus-adjustable optics according to the invention. The focus-adjustable optics can be used together with a distance measurement for an autofocus system.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

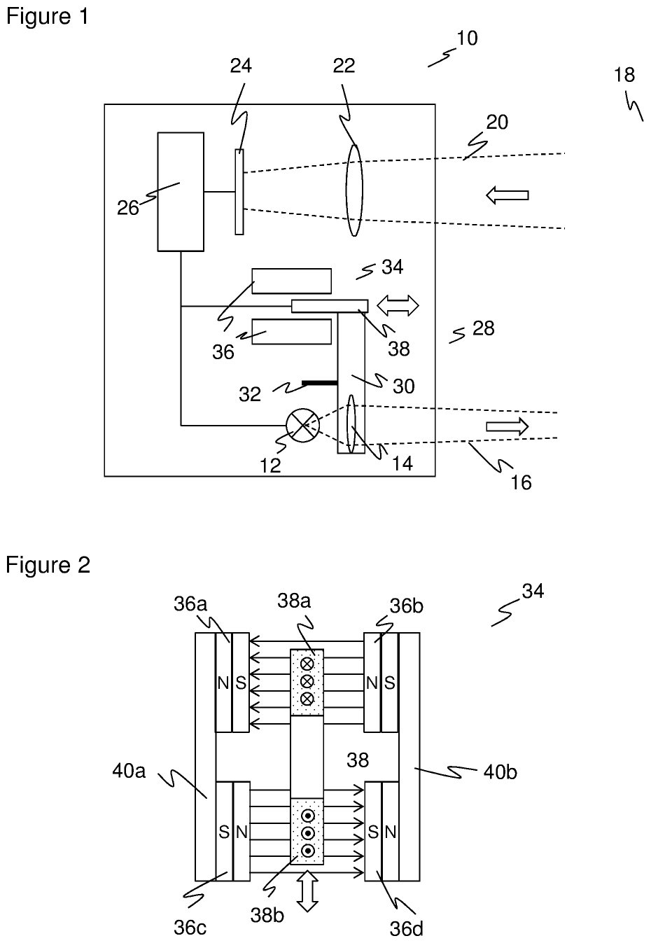

FIG. 1 a simplified block diagram of an optoelectronic sensor having a transmitting-side focus adjustment comprising a swivel arm configured as a two-sided lever and a voice coil unit;

FIG. 2 a representation of a voice coil unit with a permanent magnet and its magnetic field as well as a coil with a current flow arranged therein;

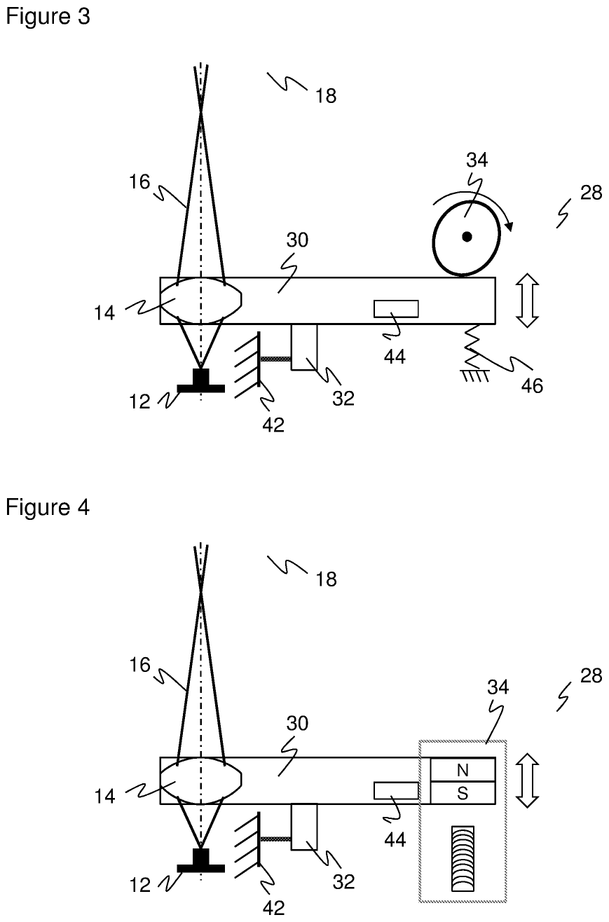

FIG. 3 a schematic representation of a focus adjustment with a two-sided lever and a stepper motor;

FIG. 4 a schematic representation of a focus adjustment with a two-sided lever and a voice coil unit;

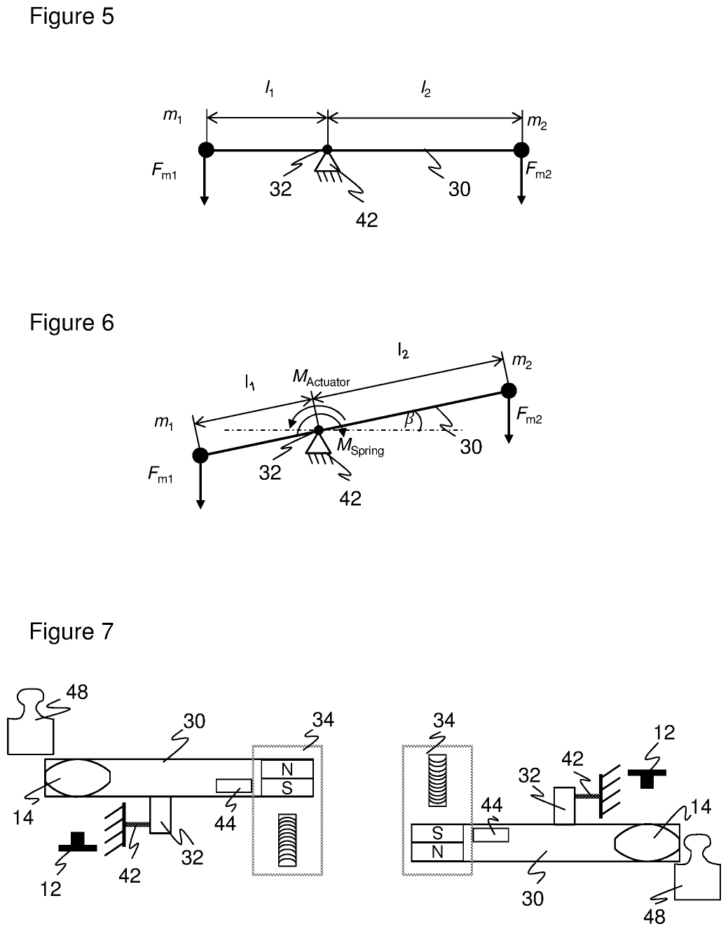

FIG. 5 a sketch of the situation at a two-sided lever in a zero position;

FIG. 6 a sketch of the situation at a two-sided lever in an offset position;

FIG. 7 a schematic diagram of the balancing of a two-sided lever for focus adjustment; and

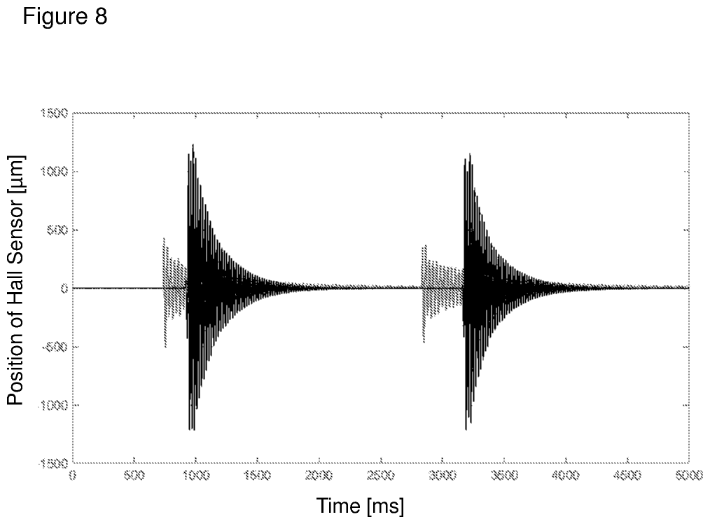

FIG. 8 a comparative representation of the movements of a balanced and an unbalanced focus adjustment in a shock test.

FIG. 1 shows a simplified block diagram of an optoelectronic sensor 10. A light transmitter 12, for example having an LED or a laser as its light source, generates transmitted light 16 which is transmitted into a detection area 18 via transmission optics 14. Transmission optics 14 are shown as a simple lens by way of example. Alternatively, a plurality of lenses of an objective are conceivable, as well as additional optical elements in the form of apertures, filters and the like. A reflexive arrangement with at least one curved mirror or a hybrid of refractive and reflective elements is also possible.

If the transmitted light 16 impinges on an object in the detection area 18, reflected or remitted light 20 returns to the sensor 10 and is guided to a light receiver 24 via reception optics 22. There, a reception signal is generated from the incident remitted light 20 and fed to an evaluation unit 26. The evaluation unit 26 is also connected to the light transmitter 12 for its control.

In order to vary the depth of field of transmission optics 14 or to focus the light spot generated by the transmitted light 16 at a certain distance, respectively, transmission optics 14 are configured as focus-adjustable optics 28. Although it is conceivable to use focus-adjustable optics 28 for focusing to a fixed or parameterised distance, preferably the respective distance to an object is measured whereon the transmitted light 16 impinges. This can be done by an additional distance measuring unit which is not shown. In a preferred embodiment, the transmitted light 16 itself is used for a distance measurement, for example by adding a frequency to the transmitted light 16 by means of amplitude modulation and determining the distance with a phase method, from the phase offset between transmitted light 16 and remitted light 20.

Focus-adjustable optics 28 will be explained later with reference to FIGS. 3 to 8. In a short description, it has a swivel arm 30 mounted like a seesaw on a bearing point 32 on its long side. The swivel arm 30 holds transmission optics 14 on one side and is moved up and down on the other side by a voice coil actuator 34, which has a stationary permanent magnet 36 and a coil 38 with a current flow on the swivel arm 30, the coil 38 being arranged in the magnetic field of the permanent magnet 36.

Movements of the swivel arm 30 vary the distance between light transmitter 12 and transmission optics 14 and thus adjust the focus. The extent of the swivel movement or the offset of the swivel arm 30 can be controlled by the evaluation unit 26 by means of the current flow through coil 38. For example, a focus table is stored which links the required controls with measured distances or otherwise defined focus positions to be set. The transmission ratio between movements at the voice coil actuator 34 and movements of transmission optics 14 is known and determined by the geometry of the swivel arm 30 and the arrangement of transmitting optics 14 on the swivel arm 30, the bearing point 32 and the point where the adjusting force is applied at the coil 38.

The sensor 10 in FIG. 1 is only shown schematically and represents various optoelectronic sensors. Accordingly, the actual configuration of the sensor 10 may differ considerably, since the invention relates to the focus-adjustable optics 28. One example is a code scanner having a scanning mechanism which is not shown, for example an oscillating or rotating mirror, that moves the transmitted light 16 over the code area as a reading beam. In case that the reading beam scans a barcode, for example, the amplitude of the reception signal is modulated in correspondence with the bars in the code. The evaluation unit 26 therefore is able to read the code information. It also detects when the reception signal does not correspond to a code. Locating code areas and reading the code information is known in itself and is therefore not explained in any detail.

The focus-adjustable optic 28 explained that has been explained for the transmitting side can also be used on the receiving side, for example in a camera-based code reader instead of a code scanner.

FIG. 2 shows an exemplary configuration of the voice coil actuator 34 with a magnetic field of the permanent magnet 36 indicated by arrows and the coil 38 arranged in the magnetic field. The permanent magnet 36 preferably has two pairs of magnets 36a-b and 36c-d, each pair generating a homogeneous magnetic field between one another, with one respective half 38a-b of the coil 38 being located in each of these homogenous magnetic fields. The upper magnet pair 36a-b and the lower magnet pair 36c-d are polarized in the opposite direction, which can simply be achieved by reversing the arrangement. This is done because the current in the upper half 38a of coil 38 flows in the opposite direction than in the lower half 38b due to the windings and arrangement. Due to the different polarization of the magnet pairs 36a-b, 36c-d, the—Lorentz force on both halves 38a-b of the coil 38 is directed in a same direction. Both magnet pairs 36a-b, 36c-d are each connected to a cover 40a-b in order to close the magnetic circuit.

FIG. 3 shows a schematic representation of focus-adjustable optics 28. The swivel arm 30 is not mounted at one end but on its long side as a two-sided lever or as a seesaw. A leaf spring 42 is arranged on the bearing at bearing point 32. Transmission optics 14 are located to the left of bearing point 32 on one lever arm, and the actuator 34 is located on the right at the other lever arm. The position accuracy of transmission optics 14 and thus the focus position can be dimensioned via the lever ratios. An optional position sensor 44 determines the respective position or offset, for example to check or adjust the current focus position, in particular in a closed-loop control. In addition, transmission optics 14 also represents focus-adjustable reception optics 22 for a different sensor configuration than that of FIG. 1.

According to the invention, the swivel arm 30 is balanced to provide more robustness against shock and vibration. In the example of FIG. 3, a stepper motor with a cam disk instead of a voice coil unit is provided as actuator 34. A preloaded spring 46 can be used underneath the stepper motor, which already largely ensures the robustness, so that balancing only makes a supplementary contribution.

FIG. 4 shows a schematic representation of focus-adjustable optic 28 similar to FIG. 3, but now with voice coil actuator 34. Its free support, for example via thin bending beams, makes focus-adjustable optics 28 of this embodiment a lot more sensitive to shock and vibration. Therefore, in this embodiment, the balancing of the swivel arm 30 leads to a considerably more robust behaviour.

FIGS. 5 and 6 are sketches of the abstracted force and torque situation for a two-sided lever, i.e. on the swivel arm 30, where FIG. 5 shows a zero position and FIG. 6 an offset position. At both lever arms, point masses m₁, m₂ are assumed at a distance l₂, l₂ to the pivot point or bearing point 32. For the balanced two-sided lever, the torques M add up to zero. If a mechanical shock is applied to the system in the form of an acceleration a, this will not have any effect due to the balancing in the ideal case.

In the zero position of FIG. 5, it holds

ΣM=0

a(m₁l₁−m₂l₂)=0

m₁l₁=m₂l₂.

With an actuator torque M_{Actuator} for an offset position as in FIG. 6, the leaf spring 42 generates a spring moment M_{Spring} with the sign reversed, and the following applies

ΣM=0

cos(β)a(m₁l₁−m₂k₂)=M_{Spring}−M_{Actuator}

since m₁l₁=m₂l₂

0=M_{Spring}−M_{Actuator}.

FIG. 7 is a schematic representation of the balancing process for balancing the two-sided lever. In this case, the balancing is carried out with additional weights 48 on the side of transmission optics 14, while the actuator 34 is out of operation. The target value of the balancing is to change the position as little as possible for the different upwards and downwards orientations. Balancing can also be performed with weights on the opposite side or by removing material. As an alternative an individual balancing, for example during the manufacturing process, balancing by design is also conceivable, in which the components and arrangements are selected and designed to achieve the balancing.

FIG. 8 shows the result of an experimental example of the time-dependent offsets of the swivel arm 30 measured by the position sensor 44 in a shock test with two shocks, each with an acceleration of 12 m/s². The values shown in lighter gray correspond to the balanced system and the values shown in darker gray correspond to the unbalanced system. It can clearly be seen that the amplitude of the unbalanced system is much higher, in this example by a factor of 2.7.

Of course, the theoretical ideal case according to FIGS. 5 and 6 of a complete robustness against shock is not possible in practice, but nevertheless a quite significant improvement. The difference to the theory is among other things due to the support with the leaf spring 42 and the mass distribution. Further improvements are possible by keeping the total mass as low as possible in order to be able to use an actuator 34 that is as compact as possible and to minimize the influence of external mechanical loading in the direction of rotation of the actuator 34.

1. Focus-adjustable optics (28) for an optoelectronic sensor (10), the focus-adjustable optics (28) having at least one optical element (14), an actuator (34) for moving the optical element (14), and a swivel arm (30), with the optical element (14) being arranged on the swivel arm (30) and the actuator (34) engaging the swivel arm (34) for moving the swivel arm (30) with the optical element (14) relative to a bearing point (32), wherein the swivel arm (30) is configured as a two-sided lever having a first lever arm on one side of the bearing point (32) and a second lever arm on another side of the bearing point (32), the optical element (14) being arranged on the first lever arm and the actuator (34) being arranged at the second lever arm, and wherein the swivel arm (30) is balanced.

2. The focus-adjustable optics (28) according to claim 1
wherein the swivel arm (30) is balanced by selection and arrangement of the swivel arm (30), the optical element (14) and the actuator (34).

3. The focus-adjustable optics (28) according to claim 1,
wherein the swivel arm (30) is balanced by adding or removing material of the swivel arm (30).

4. The focus-adjustable optics (28) according to claim 1,
wherein the swivel arm (30) is balanced by shifting at least one of the bearing point (32), the position of the optical element (14) and the position of the actuator (34) relative to the swivel arm (30).

5. The focus-adjustable optics (28) according to claim 1,
wherein a free support is provided between actuator (34) and second lever arm.

6. The focus-adjustable optics (28) according to claim 1,
wherein the actuator (34) is configured as a voice coil actuator.

7. The focus-adjustable optics (28) according to claim 1,
comprising a position sensor (44) for determining the respective position of the optical element (14).

8. The focus-adjustable optics (28) according to claim 7,
comprising a controller for controlling the focus position of the optical element (14) based on position information of the position sensor (44).

9. The focus-adjustable optics (28) according to claim 1,
wherein the swivel arm (30) is mounted and arranged with respect to the actuator (34) such that the swivel movement is perpendicular to the longitudinal-extension of the swivel arm (30).

10. The focus-adjustable optics (28) according to claim 1,
wherein the swivel arm (30) is mounted at the bearing point (32) by means of a leaf spring (42).

11. A sensor (10) comprising focus-adjustable optics (28) having at least one optical element (14), an actuator (34) for moving the optical element (14), and a swivel arm (30), with the optical element (14) being arranged on the swivel arm (30) and the actuator (34) engaging the swivel arm (34) for moving the swivel arm (30) with the optical element (14) relative to a bearing point (32), wherein the swivel arm (30) is configured as a two-sided lever having a first lever arm on one side of the bearing point (32) and a second lever arm on another side of the bearing point (32), the optical element (14) being arranged on the first lever arm and the actuator (34) being arranged at the second lever arm, and wherein the swivel arm (30) is balanced,
the sensor (10) further comprising at least one of a light receiver (24) with the focus-adjustable optics (28) being used as reception optics and a light transmitter (12) with the focus-adjustable optics (28) being used as transmission optics (14).

12. A method for adjusting a focus of focus-adjustable optics (28) of an optoelectronic sensor (10), wherein at least one optical element (14) is moved by an actuator (34) by means of the optical element (14) being arranged on a swivel arm (30) where the actuator (34) engages in order to move the swivel arm (30) with the optical element (14) relative to a bearing point (32), wherein the swivel arm (30) is formed as a two-sided lever having a first lever arm on one side of the bearing point (32) and a second lever arm on another side of the bearing point (32), the optical element (14) being arranged on the first lever arm and the actuator (34) being arranged at the second lever arm, and wherein the swivel arm (30) is balanced.
